(19) United States
(12) Patent Application Publication
(10) Pub. No.: US 2007/0115898 A1
(43) Pub. Date: May 24, 2007

(54) Use of wireline networks to access 3G wireless services

(76) Inventor: Robert C. Stein, Coopersburg, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/285,567

(22) Filed: Nov. 22, 2005

(51) Int. Cl. H04Q 7/24; H04L 12/66

(52) U.S. Cl. 370/338; 370/352

(57) ABSTRACT

Methods, devices, and computer programs for using a wireline communication network, such as a cable network (306), to access a packet-switched service (21) delivered by a 3G communication network, such as a universal mobile telecommunications system (“UMTS”) communication network (10), are described. The service is provided to a wireless communication device, such as a mobile phone (16), by the 3G network via an access node (400) in the wireline network. The access node is configured to serve as an endpoint of a packet data tunnel (506) with the phone. The packet data tunnel establishes a security association between the phone and the access node. Using the packet data tunnel, a defined level of performance for data packets communicated between the 3G network and the phone is established, and data packets are routed between the 3G network and the phone based on the defined level of performance.

### BACKGROUND

Wireless communication devices such as mobile phones have become ubiquitous in many places. Many mobile phones are capable of operation within third generation (“3G”) communication networks. 3G communication networks can handle voice (telephone calls), data, and multimedia (combinations of video, audio or data) at high data rates, using both circuit-switched and packet-switched networks as appropriate.

A circuit-switched network dedicates a physical path to a single connection between two end-points in the network for the duration of the connection. A packet-switched network (for example, an Internet Protocol (“IP”)-based network) is “connectionless,” routing relatively small units of data called data packets through a network based on a destination address contained within each packet. The same path is shared by data packets having different destination addresses.

The Universal Mobile Telecommunications System (“UMTS”) is a group of communication protocols designated for use by certain 3G communication networks (“UMTS Networks”). An organization called the Third Generation Partnership Project (“3GPP”) defines communication standards for use within UMTS Networks. The 3GPP has defined a system called the 3GPP IP Multimedia Subsystem (“IMS”), which is referred to as the “IMS System.” The IMS System is a part of the UMTS Network that is responsible for providing packet-switched services, such as Voice over Internet Protocol (“VoIP”) services, to user equipment, such as mobile phones. A wide and ever-increasing variety of user equipment and packet-switched services are available. Examples of other packet-switched services include, but are not limited to, email, web surfing, and tunneling of cellular/telephony calls.

The challenges of security and reliability posed by wireless VoIP are being addressed by the IMS System. One important feature of the IMS System is that a mobile phone can securely gain access to a packet-based service regardless of how the mobile phone accesses the IMS System. The IMS System is therefore referred to as being “access network agnostic”.

One type of mobile phone, a phone that is capable of making or receiving calls in one or more cellular modes and also in a wireless local access network (“WLAN”) mode, would take advantage of the access network agnosticism of the IMS System, allowing users of such a dual-mode phone to use their mobile phones in more environments than ever before.

In one or more cellular modes, the dual-mode phone would access the IMS System using licensed radio frequency spectrum and a cellular air interface protocol, such as a wideband code division multiple access (“W-CDMA”) air interface protocol. In the WLAN mode, the dual-mode phone would use different, generally unlicensed, radio frequency spectrum and non-cellular air interface protocols to access the IMS System. One example of a non-cellular air interface protocol is the Wireless Fidelity (“WiFi”) series of protocols promulgated by the Institute of Electrical and Electronics Engineers (“IEEE”).

The environments in which dual-mode phones could be used would be further expanded if wireline service providers such as cable television operators take advantage of the access network agnosticism of the IMS System. For example, certain changes to cable access networks would allow WLAN-enabled mobile phones to access the IMS System through wireless cable modem connections. A user could then initiate a VoIP call (and access other packet-switched services provided by a UMTS Network) using his mobile phone wherever he happened to be, in the car, in a cafe with a WiFi hotspot, in an office having wireless Internet access points, or at home with wireless access to a cable modem.

Changes to cable access networks that would allow WLAN-enabled mobile phones to access the IMS System, however, may be expensive or complicated for cable service providers to implement. There is no single piece of equipment for use in a cable access network that currently has the functionality to allow mobile phones to access the IMS System. If new or different devices are added to the cable access network to provide such functionality, the development and deployment costs of the new devices may be high. Also, additional or different interfaces between the new devices and the cable access network would likely be needed. Existing equipment in the cable access network might not be able to examine the signaling within or between the new devices, which would make it more difficult to provide appropriate levels of security and quality of service in the existing cable access network.

Cost-effective solutions for enabling users of wireless devices, such as mobile phones, to access 3G packet-switched services using cable access networks are needed. There is a need for a single piece of equipment, located within the cable access network, to serve as a point of interconnection between the cable access network and a 3G communication network, and to provide for appropriate levels of security and quality of service within the cable access network.

### BRIEF DESCRIPTION OF THE DRAWINGS

FIG. 1 is a simplified functional block diagram of a Third Generation Partnership IP Multimedia Subsystem system, which is referred to as an “IMS System”.

FIG. 2 is a message sequence chart illustrating a general process by which a mobile phone uses WLAN access network(s) shown in FIG. 1 to directly access the IMS System shown in FIG. 1.

FIG. 3 is a simplified functional block diagram of an exemplary multimedia architecture, within which the access node shown in FIG. 4 may be used.

FIG. 4 is a functional block diagram of an access node usable in the access network of the multimedia architecture shown in FIG. 3.

FIG. 5 is a message sequence chart illustrating a process by which a mobile phone uses the access node shown in FIG. 4 to access the IMS System shown in FIG. 1.

### DETAILED DESCRIPTION

Methods, devices, and computer programs for using a cable network to access a packet-switched service delivered by a 3G communication network, such as a UMTS communication network (a 3GPP IMS, for example), are discussed herein. A wireless communication device such as a mobile phone requests access to the packet-switched service, which for discussion purposes is a Voice over Internet Protocol (“VoIP”) service. The request is received by an access node, such as a cable modem termination system (“CMTS”) device, which is located in a hybrid fiber-optic/coaxial cable (“HFC”) network.

In general, the access node serves as a point of interconnection between the mobile phone and the 3G communication network. More specifically, the access node implements the packet data gateway (“PDG”) function and/or the wireless access gateway (“WAG”) function specified by a document entitled “3GPP TS 23.234 (V6.2.0), 3GPP system to Wireless Local Area Network (WLAN) interworking,” referred to as the “WLAN Interworking Specification”, published in 2004 by the Services and System Aspects Technical Specification Group of the 3GPP. In accordance with certain aspects of the WLAN Interworking Specification, the access node serves as an endpoint of a packet data tunnel, which establishes a security association between the mobile phone and the access node. The packet data tunnel may be established using an IP security (“IPSec”) protocol. The packet data tunnel is also used to establish a level of quality of service (“QoS”) for packet data communicated between the 3G communication network and the mobile phone. In this manner, security and QoS is maintained in the cable access network.

Consumers, service providers, and manufacturers would benefit from the use of the access node described herein. Consumers would experience access to services such as VoIP in more places than ever before, in a unified manner. Cable television operators could increase the applicability of their service offerings to broader market segments, without having to deploy additional equipment to implement the PDG function(s) in their HFC networks. Manufacturers may gain larger market share with fewer product development efforts.

The foregoing description has been provided to introduce a selection of concepts in a simplified form. The concepts are further described below. Elements or steps other than those described above are possible, and no element or step is necessarily required. The foregoing description is not intended to identify key features or essential features of the claimed subject matter, nor is it intended for use as an aid in determining the scope of the claimed subject matter.

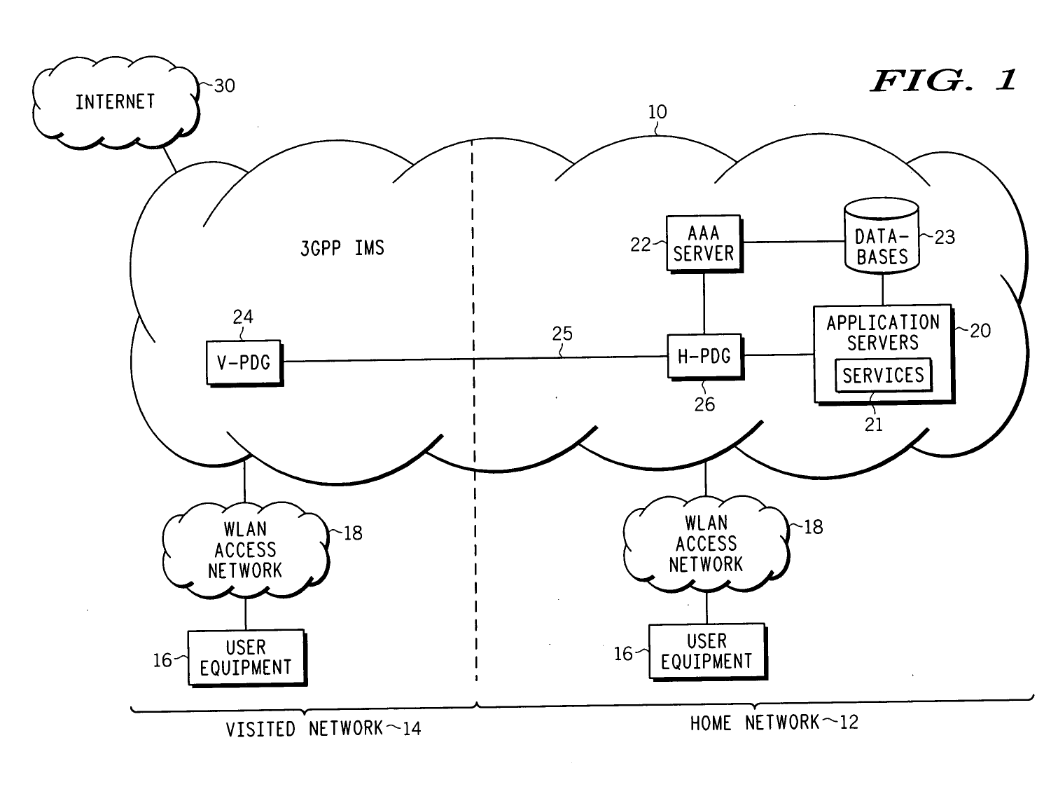

Turning to the drawings, where like numerals designate like components, FIG. 1 is a simplified functional block diagram of a Third Generation Partnership Project IP Multimedia Subsystem (“3GPP IMS”) system 10 (referred to as “IMS System 10”). User equipment 16 accesses IMS System 10 through either Home Network 12 or Visited Network 14 using wireless local area network (“WLAN”) access network(s) 18. IMS System 10 includes a visited packet data gateway (“V-PDG”) 24 in Visited Network 14 and a home PDG (“H-PDG”) 26 in Home Network 12. V-PDG 24 and H-PDG 26 are network nodes that serve as points of interconnection between WLAN access network(s) 18 and IMS System 10.

System 10 also includes authentication, authorization, and accounting (“AAA”) server 22 (described further below), databases 23, and application servers 20. Application servers 20 are computing systems having well known internal arrangements that are responsible for implementing the logic (for example, call flows, database access, and user interface interaction) for delivery of specific packet-switched services 21 to user equipment 16. Within IMS System 10, communication between functions occurs over Internet Protocol (“IP”) network 25.

For discussion purposes, user equipment 16 will be referred to as a mobile phone, and packet-switched services 21 will be referred to as Voice over Internet Protocol (“VoIP”) services. The mobile phone may be a dual-mode mobile phone, which is capable of making or receiving voice, data, and multimedia calls in both a traditional cellular mode, and in a WLAN mode. In the cellular mode, the dual-mode phone uses a radio access network (“RAN”) to communicate with the UMTS Network. A RAN supports communication over licensed radio frequency spectrum using a cellular air interface protocol, such as a wideband code-division multiple access (“W-CDMA”) air interface protocol. In the WLAN mode, the dual-mode phone uses a WLAN, such as a Wireless Fidelity (“WiFi”) network, to access the UMTS Network. A WLAN supports communication over (often unlicensed) radio frequency spectrum using non-cellular air interface protocols. WiFi refers to the 802.11 series of non-cellular air interface protocols promulgated by the Institute of Electrical and Electronics Engineers (“IEEE”).

Home Network 12 is a Universal Mobile Telecommunications System (“UMTS”) network with which mobile phone 16 is registered for use. A home network in general, and Home Network 12 in particular, is operated by a service provider with which a user of a mobile phone has contracted to receive communication services, such as VoIP services.

Visited Network 14 is a different network than Home Network 12. Visited Network 14 is often another UMTS Network in a different geographical area than Home Network 12, and may be operated by a different service provider. Roaming agreements between an operator of Home Network 12 and operators of various visited networks, such as Visited Network 14, allow mobile phone users to access packet-switched services offered by their home networks when roaming in geographical areas served by visited networks.

WLAN access networks 18 provide mobile phone 16 with direct or indirect access to IMS System 10. A document entitled “3GPP TS 23.234 (V6.2.0), 3GPP system to Wireless Local Area Network (WLAN) interworking” (referred to herein as the “WLAN Interworking Specification”) is incorporated by reference into this document. The WLAN Interworking Specification was published in 2004 by the Services and System Aspects Technical Specification Group of the 3GPP, and its stated intent is to extend 3GPP services and functionality to the WLAN access environment.

One important feature provided by the WLAN Interworking Specification is that it is “access network agnostic.” Access network agnostic means that a user endpoint (a user endpoint is any equipment in possession of a user), such as mobile phone 16, can securely access IMS System 10 regardless of the access network or access point used.

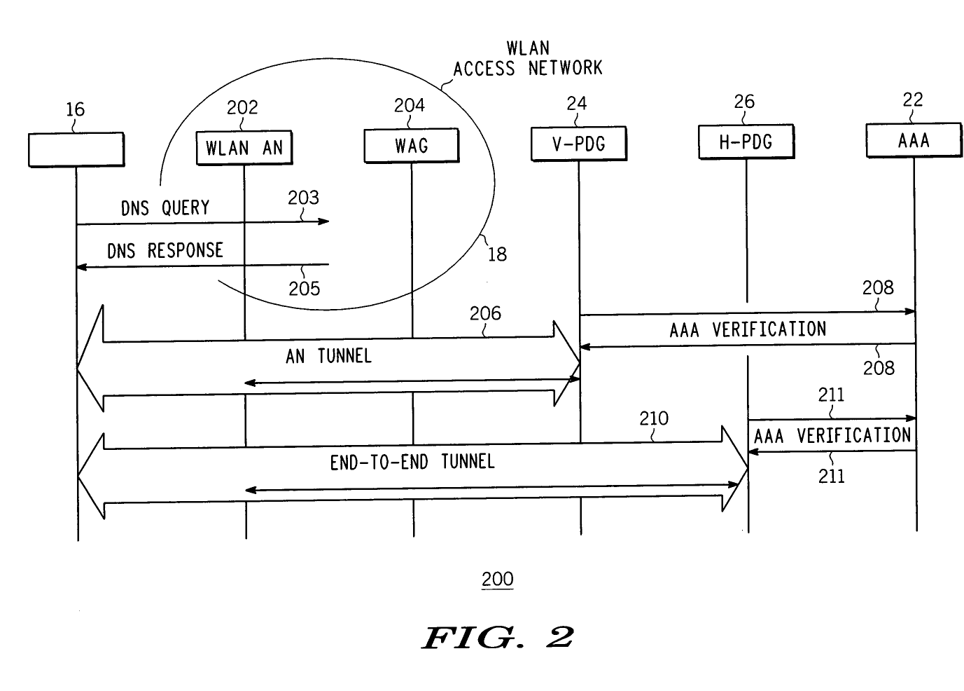

With continuing reference to FIG. 1, FIG. 2 is a message sequence 200 chart illustrating one example of the operation of system 10 in accordance with the WLAN Interworking Specification. FIG. 2 illustrates the case where WLAN access network(s) 18 provide direct access to IMS System 10. Mobile phone 16 uses WLAN access network 18 in Visited Network 14 to directly access IMS System 10 to place a VoIP call, cellular call, or use another IP multimedia service supported by the subscriber's Home Network 12. For example, a mobile phone user who has traveled away from home places a call in the vicinity of a WLAN access network or access point, such as a local WiFi hotspot in a coffee shop or an airport. VoIP services 21 are supplied by application servers 20 in the user's Home Network 12.

First, mobile phone 16 attempts to register with Home Network 12. The mobile phone performs a Domain Name System (“DNS”) query 203 to obtain, within DNS response 205, the IP address(es) of certain functions within Home Network 12, such as the IP addresses of H-PDG 26 or AAA server 22. WLAN access network 18 receives DNS query 203 and produces DNS response 205.

WLAN access network 18 includes a WLAN access point, such as a WLAN access node (“WLAN AN”) 202, and one or more intermediate elements, such as a WLAN access gateway (“WAG”) 204. WAG 204 is an element specified by the WLAN Interworking Specification that is responsible for routing data to/from the WLAN access network 18. Among other things, WAG 204 allows billing information to be generated for users accessing IMS System 10 through visited networks, such as Visited Network 14. WAG 204 also implements the correct routing of data packets before and after the establishment of access network tunnel (“AN tunnel”) 206 (discussed further below) and end-to-end tunnel 210 (also discussed further below), and serves as a filter for data packets. A filter functions as a firewall, it determines which data packets to allow through the firewall.

Next, V-PDG 24 and/or H-PDG 26 use AAA server 22 to perform authentication, authorization, and accounting (“AAA”) activities that allow admission of mobile phone 16 into IMS System 10. Visited Network 14 (and V-PDG 24) may not have enough information to authenticate mobile phone 16, so AAA 22 within Home Network 12, which stores the authentication credentials of mobile phone 16, may be contacted. Data packets relating to AAA activities are forwarded by WAG 204 to V-PDG 24, and the information is used by service providers for billing purposes.

AAA activities have been defined and standardized by the Internet Engineering Task Force (“IETF”). Authentication is the process of identifying a user. Authorization is the process of enforcing policies, determining what types or qualities of activities, resources, or services the user is permitted to use. Authentication may also encompass the authorization process. In the process of authentication, for example, certain service profiles (information regarding approved services and service options, such as voicemail greetings, call forwarding information, and the like) may be established. Accounting measures the billable resources a user accesses during use of a system. Examples of billable resources include the amount of time a user has spent using a particular system, or the amount of data a user has sent or received using the system.

Each mobile phone registered for use in IMS System 10 has a unique set of authentication credentials used for gaining access to IMS System 10. As indicated by arrows 208, V-PDG 24 relays data packets generated by mobile phone 16 to AAA 22, to confirm that validity of the authentication credentials of mobile phone 16. AAA server 22 compares mobile phone 16's authentication credentials against authentication credentials stored in database 23 (shown in FIG. 1), which may be a home subscriber service database or another type of data storage device. If the authentication credentials match, mobile phone 16 is granted access to IMS System 10. If the authentication credentials do not match, authentication fails and access to IMS System 10 may be denied. AAA 22 also records all access activity, which is used by service providers for billing purposes.

Once mobile phone 16 is authenticated and authorized to use VoIP service 21, AAA 22 assigns mobile phone 16 an IP address, which functions as the mobile phone's identity for the duration of the handset's registration through this Visited Network.

Using the mobile phone's assigned IP address, AN tunnel 206 is established between mobile phone 16 and V-PDG 24. A tunnel is a bidirectional, secure, logical connection between two entities. Tunnels are used when it is desirable to authenticate or encrypt data. Tunnels specify a security association between the connected entities, and the security association defines the parameters for the authentication and encryption algorithms. A security association is specified using a Security Parameter Index (“SPI”) and the IP address of an entity. The SPI and the IP address together uniquely identify a particular security association. The SPI is a number, which may be pseudo-randomly derived or manually specified.

Within AN tunnel 206, communications between network devices such as mobile phone 16 and devices that implement functions within IMS System 10, such as WAG 204, V-PDG 24, or H-PDG 26, pass through, at each network interface, seven vertical layers of the well-known abstract model that defines internetworking (the “Internetworking Model”): layer 1, the Physical Layer; layer 2, the Data Link Layer; layer 3, the Network Layer; layer 4, the Transport Layer; layer 5, the Session Layer; layer 6, the Presentation Layer; and layer 7, the Application Layer.

At the Application Layer, mobile phone 16 uses a predetermined application-layer protocol, such as the Session Initiation Protocol (“SIP”), for communicating with V-PDG 24. SIP is an IETF standard protocol for the initiation, management, and termination of multimedia sessions between users of IP-based networks.

At the transport layer, security of individual data packets traveling via AN tunnel 206 is provided by IP Security (“IPsec”) protocols. IPsec protocols were also developed and promulgated by the IETF.

AN tunnel 206 is used for the establishment of additional access rules/policies, such as establishment of appropriate levels of quality of service (“QoS”) within access network 18. V-PDG 26 ensures an appropriate level of QoS for the call within AN tunnel 206.

A level of QoS is a defined level of performance in a data communications system. In a VoIP context, an appropriate level of QoS ensures that VoIP calls are delivered without annoying blips. UMTS networks, including IMS Systems, offer four different levels of QoS for four types of traffic: conversational class (voice, video telephony, video gaming); streaming class (multimedia, video on demand, webcast); interactive class (web browsing, network gaming, database access); and background class (email, short messaging service, and downloading).

Finally, an end-to-end tunnel 210 is established between mobile phone 16 and H-PDG 26. Note that AAA activities are also performed at this stage of the mobile phone's access to IMS System 10, as shown by arrows 211. Using end-to-end tunnel 210, data packets from mobile phone 16 are forwarded to particular application servers 20 that provide VoIP service 21. H-PDG 26 registers the endpoints of end-to-end tunnel 210 and routes SIP messages to the appropriate application server 20. Thus, the user of mobile phone 16 is able to carry on a VoIP call using IMS System 10, and appropriate levels of security and QoS are maintained within WLAN access network 18.

The user of mobile phone 16 may also want to use his phone to place VoIP calls in areas without good RAN access to IMS System 10, or without WLAN access networks 18 that directly access IMS System 10. For example, the user may want, but be unable, to use the VoIP service he has on his mobile phone at home, but he does not have good cellular coverage at home, and his Internet access, even if it is wirelessly accessible, is provided by his cable company. It would be desirable if a WLAN-equipped cable modem, for example, could serve as a wireless access point for a dual-mode cellular/WLAN mobile phone, and if the mobile phone could use the cable access network to indirectly access IMS System 10 to make a VoIP call, in a manner transparent to the user of the mobile phone.

Because IMS System 10 is access network agnostic, wireline service providers such as cable television operators, which operate packet-switched networks such as hybrid fiber optic/coaxial cable (“HFC”) networks, are in fact positioned to enable their networks to serve as access networks to IMS System 10.

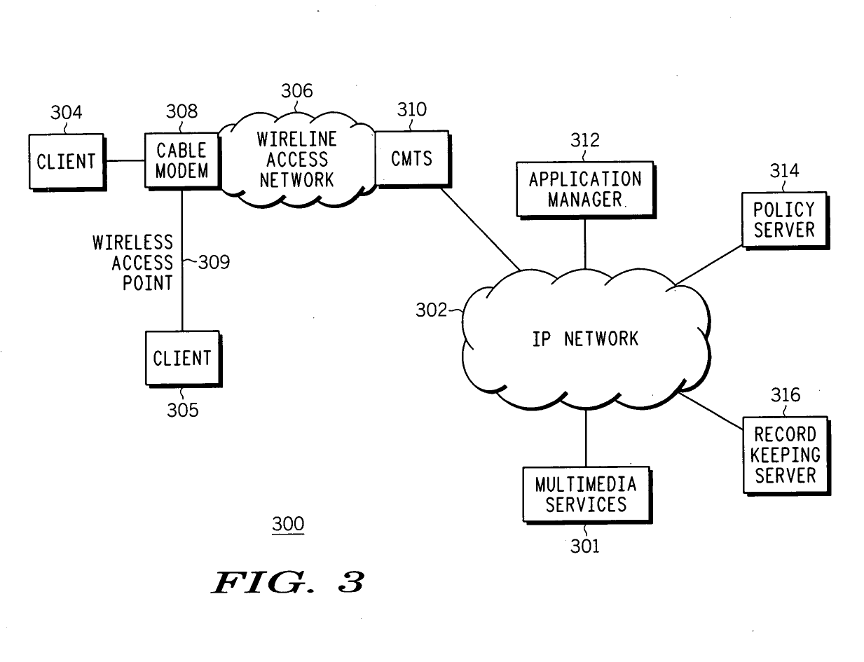

FIG. 3 is a simplified functional block diagram of a generic multimedia architecture 300 for delivering multimedia services over a two-way HFC cable network. Multimedia services 301 are provisioned within IP network 302 and delivered to a clients 304 and 305 using wireline access network 306. Clients 304 and 305 are generally software applications disposed in user devices such as computers and mobile phones, respectively. Client 305 is configured for wireless communication with WLAN access point 309.

Wireline access network 306 generally uses the Data Over Cable Service Interface Specification (“DOCSIS®”) set of protocols and standards (for example, DOCSIS 1.1 or DOCSIS 2.0) to transfer data packets between an infrastructure device 308 (such as a cable modem) and a device 310 that serves as a point of connection between wireline access network 306 and IP network 302, such as a cable modem termination system (“CMTS”). It will be appreciated that other protocols and standards may be used in different types of wireline access networks.

In multimedia architecture 300, certain activities (analogous to authentication, authorization, and accounting activities performed by AAA server 22 (shown in FIG. 1) allow admission of client 304 to multimedia architecture 300. Such activities are performed by application manager 312 and policy server 314, and records of such activities are maintained by a record keeping server 316. In addition, application manager 312 and policy server 314 are used to establish appropriate QoS levels for the delivery of multimedia services 301 to client 304. Application manager 312 requests a level of QoS on behalf of a client application 304, and policy server 314 is used to authorize and commit to the QoS request(s).

Multimedia architecture 300 could provide support for WLAN-enabled mobile phones wishing to use access network 306 to indirectly access IMS System 10, so that users could make VoIP calls and obtain other services. If the multimedia architecture implements the protocols set forth in the WLAN Interworking Specification for accessing IMS System 10 using a visited network (which is generally desirable to avoid requiring mobile phone manufacturers to incorporate an additional set of standards into mobile phones), then a further increase in the environments in which users could use their mobile phones and other wireless devices would be realized.

The WLAN Interworking Specification provides that the IMS System's AAA server 22 (shown in FIG. 1) supplies an IP address to user endpoints such as mobile phones that desire to receive services from the IMS System. The WLAN Interworking Specification also requires that a mobile phone must locate a PDG in the mobile phone's home network to receive services from the IMS System.

As shown and discussed in connection with FIGS. 1 and 2, a mobile phone roaming outside of the geographic area covered by its home network engages in a two-step process to access services 21 provided by IMS System 10, with certain AAA activities being performed at each step. First, a PDG in the visited network is contacted (for example, V-PDG 24 in Visited Network 14), and the PDG in the visited network performs certain AAA activities required to admit the user into IMS System 10 and to receive an IP address. Second, a PDG in the home network is contacted (for example, H-PDG 26 in Home Network 12), and the PDG in the home network also performs certain AAA activities before coordinating the supply of services (with application servers 20) to the IP address assigned to the user.

Referring again to FIG. 3, if multimedia architecture 300 does not include a PDG-like function in access network 306, then a mobile phone accessing an IMS System indirectly using multimedia architecture 300 would not receive the benefit of tunnels in wireline access network 306, which provide both security and a mechanism to enforce QoS levels in the access network. If, on the other hand, multimedia architecture 300 does specify a PDG-like function in access network 306, and if the function is implemented by device manufacturers using additional equipment, it may be an overly expensive or complicated solution for cable television operators to implement. It is generally desirable to minimize the amount of new equipment that service providers must install to achieve new functionality. In this manner, costs are controlled not only for service providers, but also for their customers.

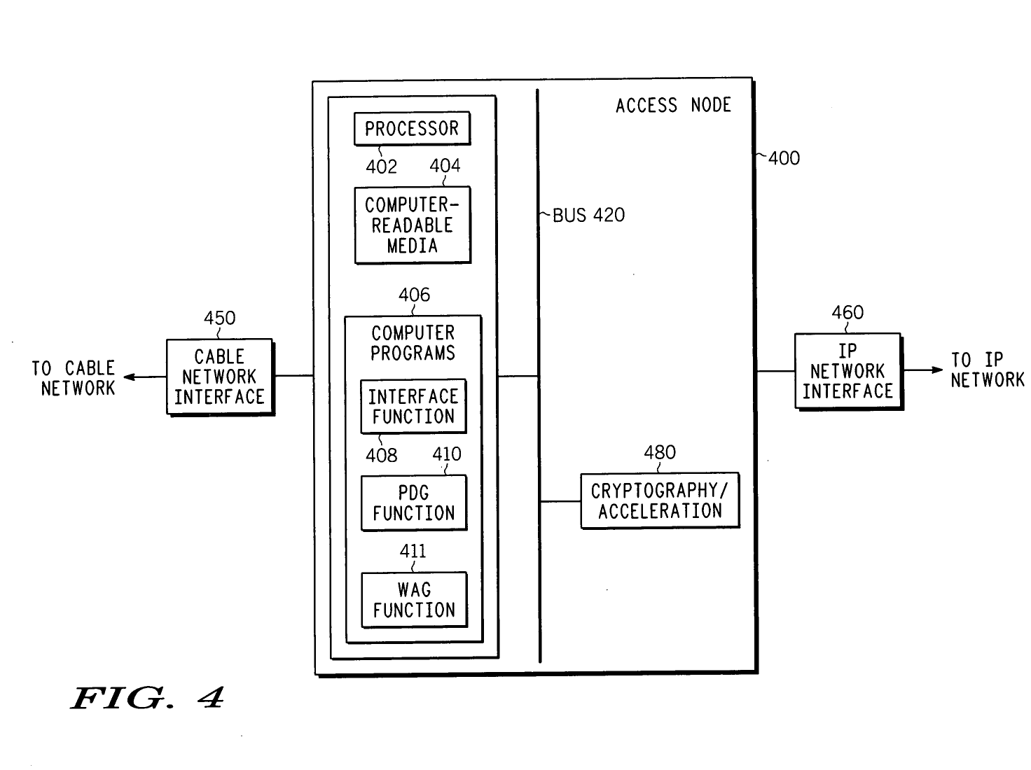

FIG. 4 is a functional block diagram of an access node 400 usable in access network 306 (shown in FIG. 3) to provide access to packet-switched services supplied by IMS System 10 to a WLAN-enabled client, such as client 305 in mobile phone 16) that communicates wirelessly with cable modem 308 equipped with WLAN access point 309. One example of a commercially available CMTS in which the functions of access node 400 may be implemented is Motorola's BSR64000 CMTS.

Computing unit 430 includes certain functional components that may be used to implement, may be accessed by, or may be included in, access node 400. A processor 402 is responsive to computer-readable media 404 and to computer programs 406.

Processor 402, which may be a real or a virtual processor, controls functions of access node 400 by executing computer-executable instructions.

Computer-readable media 404 represents any number and combination of computer readable media, in any form, now known or later developed, capable of recording or storing computer-readable data. In particular, computer-readable media 404 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media may also include data embodied in any form of wireline or wireless transmission, such as packetized and/or non-packetized data carried by a modulated carrier signal.

Computer programs 406 represent any signal processing methods or stored instructions that electronically control predetermined operations on data. In general, computer programs 406 are computer-executable instructions implemented as software components according to well-known practices for component-based software development, and encoded in computer-readable media (such as computer-readable media 404). Computer programs 406, however, may be implemented in software, hardware, firmware, or any combination thereof.

Cable network interface 450 represents one or more interconnections, within the Internetworking Model, between wireline access network 306 (for example, an HFC cable network) and access node 400.

IP network interface 460 represents one or more interconnections, within the Internetworking Model, between access node 400 and both IP network 302 associated with multimedia architecture 300 (shown in FIG. 3) and IP network 25 (shown in FIG. 1) associated with IMS System 10 (also shown in FIG. 1).

Interface function block 408 represents aspects of the functional arrangement of various computer programs 406 that pertain to the receipt and processing of data packets by access node 400. Data packets received at a given network interface, such as cable network interface 450 or IP network interface 460, may traverse one or more of the seven vertical layers of the Internetworking Model. As such, interface function block 408 may represent data interfaces, operations support interfaces, and the like (implemented, for example, by routers, switches, modems, or other network connection support devices or software).

PDG function block 410 represents aspects of the functional arrangement of various computer programs 406 that implement PDG functions for a visited network, as set forth in the WLAN Interworking Specification. Such PDG functions include, but are not limited to, the ability of access node 400 to terminate IPsec tunnels, the ability of access node 400 to admit a WLAN-enabled client 305 to IMS System 10 using multimedia architecture 300 by interacting with application manager 312 and/or policy server 314, and the ability of access node 400 to establish QoS levels in access network 306 that are compatible with QoS levels established in IMS System 10.

WAG function block 411 represents aspects of the functional arrangement of various computer programs 406 that implement WAG functions (discussed in connection with FIG. 2) set forth in the WLAN Interworking Specification.

Cryptography/acceleration hardware block 480 represents well-known hardware, firmware, or software needed terminate IPsec tunnels, which are often encrypted and therefore computation-intensive to manage. One example of an implementation of cryptography/acceleration hardware block 480 is a collection of commercially available semiconductors that support different types of encryption/decryption standards specified by the IETF for use with IPsec tunnels.

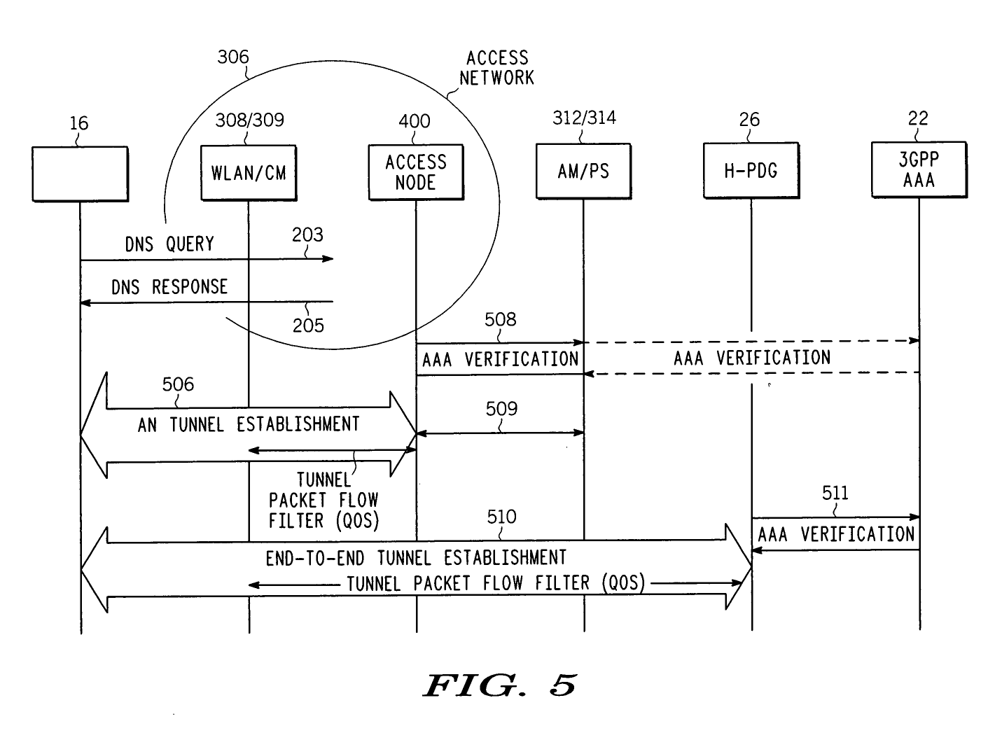

With continuing reference to FIGS. 1-4, FIG. 5 is a message sequence chart illustrating a process by which a WLAN-enabled device, such as mobile phone 16, uses access node 400 to gain access to IMS System 10 using a wireline access network to place a VoIP call. For exemplary purposes, access node 400 is implemented by a CMTS in a cable access network.

For discussion purposes, assume that the user of mobile phone 16 discussed in connection with FIG. 2 has returned home, and wishes to place a VoIP call using his mobile phone. There is no reliable cellular coverage in his house, but he does have wireless Internet access through his cable modem. The mobile phone user places the VoIP call inside his house, and mobile phone 16 uses WLAN access point 309 that is associated with cable modem 308 to contact wireline access network 306, which provides indirect access to IMS System 10.

First, mobile phone 16 attempts to register with its Home Network. Associating mobile phone 16 with WLAN access point 309 uses well-known procedures, such as those defined for IEEE 802.11 access points. A DNS query 203 is performed to obtain, within DNS response 205, the IP address(es) of certain functions within Home Network 12, such as the IP addresses of H-PDG 26 or AAA server 22. Wireline access network 306 receives DNS query 203 and produces DNS response 205. As shown, wireline access network 306 includes cable modem 308, which is equipped with WLAN access point 309, and access node 400.

Next, PDG function 410 within access node 400 uses application manager 312 and policy server 314 to perform and/or coordinate AAA activities, represented by arrows 508. Data packets relating to AAA activities are forwarded, via application manager 312 and policy server 314, by access node 400 to AAA server 22. If AAA server 22 determines that mobile phone 16 has valid authentication credentials, mobile phone 16 is granted access to IMS System 10. Once mobile phone 16 is authenticated and authorized to use VoIP service 21, AAA 22 assigns mobile phone 16 an IP address, which functions as the mobile phone's identity for the duration of the handset's registration through this Visited Network.

Using the mobile phone's assigned IP address, AN tunnel 506 is established between mobile phone 16 and access node 400. Thus, a security association is established between mobile phone 16 and access node 400. At the Application Layer, mobile phone 16 uses SIP for communicating with access node 400, and at the transport layer, security of individual data packets traveling within AN tunnel 506 is provided by IPsec protocols.

Appropriate levels of QoS are established by application manager 312 and/or policy server 314 using AN tunnel 506, as represented by arrows 509. Access node 400 ensures the appropriate levels of QoS for the call within AN tunnel 506.

Finally, end-to-end tunnel 510 is established between mobile phone 16 and H-PDG 26. Note that AAA activities are also performed at this stage, as shown by arrows 511. Using end-to-end tunnel 510, data packets are forwarded between mobile phone 16 and appropriate application server(s) 20 that provides VoIP service 21.

Thus, the user of mobile phone 16 is able to carry on a VoIP call using VoIP service 21 in IMS System 10, with access node 400 being disposed in wireline access network 306 and serving as a point of interconnection between mobile phone 16 and IMS System 10. Appropriate levels of security and QoS are maintained by access node 400 wireline access network 306.

Consumers, service providers and manufacturers would benefit from the use of access node 400 within a wireline access network. Consumers would experience access to services such as VoIP in more places than ever before, in a unified manner. Service providers (both cellular service providers and cable television operators) could increase the applicability of their service offerings to broader market segments, and also spread out the costs of delivering those services over more users. Use of access node 400 would also provide service providers with a straightforward upgrade path to virtually any solution that would allow mobile phones to roam into IMS Systems indirectly via multimedia architecture 300. Using access node 400, service providers would not necessarily be required to deploy completely new PDG systems in their HFC networks. Equipment and software makers may gain larger market shares with fewer product development efforts, because packet-switched services developed for use within IMS Systems could be used by user equipment operating in both wireline and wireless networks.

Moreover, use of access node 400 provides the ability to support delivery of appropriate QoS for wireless access through the cable access network. Integration of the PDG function within access node 400 allows access network devices to examine signaling, and to establish QoS in a secure manner, without creating additional or different interfaces between the PDG function and the access network. This is much more difficult when the PDG is a separate device, because access network devices may not be able to examine the signaling.

Exemplary configurations of user endpoints 16, IMS System 10, multimedia architecture 300, access node 400, and elements thereof have been described. It will be appreciated that such configurations may include fewer, more, or different components or functions than those described.

For example, user endpoints include any equipment in possession of an end user, including but not limited to a personal or office-based computer system, any type of communication device or adapter, a media system, and the like, either standing alone, or included in other devices. Packet-switched services are any services, now known or later developed, that are delivered using packet-switched technology, including telephony and non-telephony services (for example, messaging, fax services, email services, Internet access services, navigation services, gaming, video conferencing, video streaming, and multimedia provisioning). AAA 22, application manager 312, and policy server 314 may be implemented by one or more devices, co-located or remotely located, in a variety of ways.

It will be further appreciated that aspects of computer programs are not limited to any specific embodiments of computer software or signal processing methods. Functions described herein are processes that convey or transform data in a predictable way, and may generally be implemented in hardware, software, firmware, or any combination thereof.

Moreover, while certain elements described herein may function as “agents” or “clients”, such elements need not be implemented using traditional client-server architectures in which computer application programs are configured to cause clients, such as consumer devices, to request services from server-based service providers in a network, but may be implemented in any suitable manner.

When one element is indicated as being responsive to another element, the elements may be directly or indirectly coupled. Connections depicted herein may be logical or physical in practice to achieve a coupling or communicative interface between elements. Connections may be implemented as inter-process communications among software processes.

It will be still further appreciated that other and further forms of the embodiments may be devised without departing from the spirit and scope of the appended claims, and it is therefore intended that the scope of this invention will be governed by the following claims.

1. A method for using a cable network to access a packet-switched service delivered by a 3G communication network, the method comprising:
at an access node having a cable network interface and an internet protocol (“IP”) network interface, receiving a request from a wireless communication device to access the packet-switched service;
based on the request, causing the access node to serve as an endpoint of a packet data tunnel, the packet data tunnel establishing a security association between the wireless communication device and the access node;
using the packet data tunnel, establishing a defined level of performance for packet data communicated between the 3G communication network and the wireless communication device; and
using the packet data tunnel, routing the packet data between the 3G communication network and the wireless communication device based on the defined level of performance,
wherein the packet-switched service is provided to the wireless communication device by the 3G communication network using the access node as a point of interconnection between the wireless communication device and the 3G communication network.

2. The method according to claim 1, wherein the cable network comprises a hybrid fiber-optic/coaxial cable network.

3. The method according to claim 1, wherein the 3G communication network comprises a universal mobile telecommunications system (“UMTS”) communication network.

4. The method according to claim 3, wherein the UMTS communication network comprises a Third Generation Partnership Project IP Multimedia Subsystem.

5. The method according to claim 1, further comprising:
based on the request, prior to causing the access node to serve as an endpoint of a packet data tunnel, performing an authorization function in conjunction with the UMTS communication network.

6. The method according to claim 1, wherein the packet-switched service comprises one of an IP multimedia service and a cellular signaling protocol.

7. The method according to claim 1, wherein the wireless communication device comprises a mobile phone.

8. The method according to claim 1, wherein the access node comprises a cable modem termination system.

9. The method according to claim 8, wherein the cable modem termination system comprises a wireless access gateway associated with the UMTS communication system.

10. The method according to claim 8, wherein the cable modem termination system implements a packet data gateway (“PDG”) function specified by a document entitled “3GPP TS 23.234 (V6.2.0), 3GPP system to Wireless Local Area Network (WLAN) interworking.”

11. The method according to claim 1, wherein the packet data tunnel is established using an IP Security (“IPSec”) protocol.

12. The method according to claim 1, wherein the packet data tunnel is established by the wireless communication device.

13. A computer-readable medium having computer-executable instructions which, when executed by a computer, perform a method comprising:
at an access node having a cable network interface and an internet protocol (“IP”) network interface, receiving a request from a wireless communication device to access a packet-switched service;
based on the request, causing the access node to serve as an endpoint of a packet data tunnel, the packet data tunnel establishing a security association between the wireless communication device and the access node;
using the packet data tunnel, establishing a defined level of performance for packet data communicated between a 3G communication network and the wireless communication device; and
using the packet data tunnel, routing the packet data between the 3G communication network and the wireless communication device based on the defined level of performance,
wherein a packet-switched service is provided to the wireless communication device by the 3G communication network using the access node as a point of interconnection between the wireless communication device and the 3G communication network.

14. The computer-readable medium according to claim 13, further comprising:
based on the request, prior to causing the access node to serve as an endpoint of a packet data tunnel, performing an authorization function in conjunction with the 3G communication network.

15. The computer-readable medium according to claim 13, wherein the packet-switched service comprises one of an IP multimedia service and a cellular signaling protocol.

16. The computer-readable medium according to claim 13, wherein the wireless communication device comprises a mobile phone.

17. The computer-readable medium according to claim 13, wherein the access node comprises a cable modem termination system.

18. The computer-readable medium according to claim 17, wherein the cable modem termination system implements a packet data gateway (“PDG”) function specified by a document entitled “3GPP TS 23.234 (V6.2.0), 3GPP system to Wireless Local Area Network (WLAN) interworking.”

19. A network access node, comprising:
a cable network interface responsive to a cable network, the cable network interface operative to receive, via the cable network, a request from a wireless communication device to access a packet-switched service delivered by a UMTS communication network;
an IP network interface responsive to an IP network associated with the UMTS communication network; and
a processor responsive to a computer program, the computer program, when loaded into the processor, operative to:
when the request is received by the cable network interface, cause the IP network interface to serve as an endpoint of a packet data tunnel, the packet data tunnel establishing a security association between the wireless communication device and the network access node;
using the packet data tunnel, establish a defined level of performance for packet data communicated between the UMTS communication network and the wireless communication device; and
using the packet data tunnel, route the packet data between the UMTS communication network and the wireless communication device based on the defined level of performance,
wherein the packet-switched service is provided to the wireless communication device by the UMTS communication network using the network access node as a point of interconnection between the wireless communication device and the UMTS communication network.

20. The network access node according to claim 19, wherein the IP network interface comprises a packet data gateway (“PDG”) function specified by a document entitled “3GPP TS 23.234 (V6.2.0), 3GPP system to Wireless Local Area Network (WLAN) interworking.”

21. The network access node according to claim 20, wherein the PDG function is implemented in a visited network associated with a user of the wireless communication device.

22. The network access node according to claim 21, wherein communication over the cable network uses a data over cable service interface specifications (“DOCSIS(R)”) protocol.

23. The network access node according to claim 19, wherein the cable network interface is operative to receive the request to access the packet-switched service delivered by the UMTS communication network from a mobile phone.
